(19) United States
(12) Patent Application Publication
(10) Pub. No.: US 2011/0008482 A1
(43) Pub. Date: Jan. 13, 2011

(54) SYSTEM FOR THE MANUFACTUR OF CHOPPED STRANDS MADE OF THERMOPLASTIC MATERIAL

(76) Inventors: Dominique Font, Saint Baldoph (FR); Michel Bastard, Gresy Sur Aix (FR)

Correspondence Address: Calfee, Halter & Grlswold LLP, 800 Superior Ave E, Suite 1400, Cleveland, OH, 44114, US

(21) Appl. No.: 12/599,449

(22) PCT Filed: May 9, 2008
(86) PCT No.: PCT/US2008/063154

§ 371 Date: Sep. 28, 2010

(30) Foreign Application Priority Data
May 11, 2007 (FR) 07 55025

(51) Int. Cl. B28B 11/14

(52) U.S. Cl. 425/294

(57) ABSTRACT

A chopping machine chops strands of thermoplastic material coming from a single die into sections having a predetermined length. The machine has a substantially cylindrical chopping wheel provided on its periphery with a number of uniformly distributed blades oriented about an axis of rotation. An anvil wheel wrapped in a plastic material is located adjacent the chopping wheel. The anvil wheel has a device for routing strands between the wheels, thereby drawing out and chopping the strands into sections. The device has two or more pins that project laterally from a face of the anvil wheel. The pins may be movable with respect to the face. A restart process using the chopping machine is also provided.

### TECHNICAL FIELD AND INDUSTRIAL APPLICABILITY OF THE INVENTION

The present invention relates to the domain of manufacture of chopped strands made of thermoplastic material, particularly of glass strands, and it relates more specifically to a system for the manufacture of such strands.

### BACKGROUND OF THE INVENTION

Numerous devices capable of carrying out such manufacturing operations are known. These systems generally include at least one die from which the glass strands are drawn and led to a chopping device consisting, for example, of a support cylinder or anvil that cooperates with a chopping cylinder equipped with blades regularly distributed on its periphery. The chopper is arranged so as to come in contact under pressure with the circumferential surface of the support cylinder, thus defining a chopping zone.

French certificate of addition FR 2 075 019 illustrates a system of this type in which a die is associated with a single chopping device.

In order to increase the productivity of chopped strand manufacturing installations, solutions have been imagined according to which a number of dies feed a single chopping device. French Patent FR 2 490 251 illustrates a solution of this type. These techniques have the advantage a priori of having a single chopping machine associated with a number of dies.

However, with use, these installations display a number of disadvantages: first, rapid wear and tear on the chopping cylinders that in effect have to chop very large quantities of strands. On the order of 20 metric tons of chopped strands are ordinarily produced per day so that the chopping cylinders must be replaced after 10 to 12 hours of operation. This configuration has the following disadvantages:
loss of glass flowing from the dies
a disturbed heat balance of the dies and channel.

Furthermore, since numerous strands feed a single chopper, the dispersion with regard to the flow rate of glass from each die obliges one to consider the average of the flow rates for calculation of the speed of the chopping device. Or a high standard deviation for the size that is unsatisfactory with regard to the quality of the finished product, and the more off standard the die is the proportionally lower the yields become.

Furthermore, the current tendency consists of increasing the number of filaments per strand. Each strand thus becomes more and more difficult to chop. This results in irregular cuts with sprigs of varying fineness and consequently a non-homogeneous density of the final product. An increase in the chopping pressure should also be noted, which prematurely wears out the wheels and can bring about fusing.

In the particular case of certain reinforcements (in the case of BMC, Bulk Molding Compound, for example), it is necessary to chop a strand of well determined size (expressed in tex) that is often smaller than that for which a die is designed. In this type of production, it is therefore necessary to separate the roving into multiple thinner strands (for example, 16 or 32). In this case, the production occurs using a chopper only dealing with a single die.

Another significant problem connected with this idea relates to rupturing of the strands. These ruptures or “breaks” induce a human intervention in order to restart the strand in the chopping machine. This incident is particularly detrimental to the production yield because it requires a relatively long preparation time.

Furthermore, the break from one die can interact and generate, by winding on a guide component, a break from the other dies with the need in that case for a restart from all the dies. This human intervention in effect requires a very long time of interruption of production since the operator must then successively restart each of the strands.

It can be observed that the choppers for several dies are generally relatively large, which makes them difficult to integrate. From a relatively complex and therefore expensive technology, the current tendency consists of a return to the technical solution of a single die, while looking for more economical solutions in terms of design, maintenance.

### SUMMARY OF THE INVENTION

The present invention proposes a solution to the problems mentioned above. It makes it possible to increase the productivity of such systems, to reduce the costs of production while meeting the new expectations of the clients.

More precisely, the present invention makes it possible to do restarts without having to use a restart wheel.

For this purpose, the present invention relates to a chopping machine intended for chopping sections from strands of thermoplastic material, of determined length, the strands coming from a single die, said machine having an essentially cylindrical chopping wheel provided on its periphery with a number of uniformly distributed blades oriented essentially according to the direction of its axis of rotation, an anvil wheel lined by means of a wrapping made of plastic material, said anvil wheel being in the vicinity of the chopping wheel, and a device enabling the strands to be routed between the wheels making it possible to draw out and chop the strands into sections, characterized by the fact that the anvil wheel is provided on the façade with at least two pins projecting laterally with each arranged in one of the four quadrants forming said façade.

Thanks to these pins present on the façade of the anvil wheel, the chopping machine has a simple design and is therefore inexpensive in terms of execution as well as maintenance and moreover offers the possibility of making restart operations possible without the use of a restart wheel.

### DETAILED DESCRIPTION AND PREFERRED EMBODIMENTS OF THE INVENTION

In some preferred embodiments of the invention, moreover, one and/or another of the following arrangements can possibly be used:
the anvil wheel has at least 3 pins uniformly distributed on the façade of the anvil wheel.
the anvil wheel is provided with at least one notch situated on the edge of the external surface of the wrapping and at a right angle with respect to the façade of the anvil wheel.
the pins are mounted in a removable manner.
the notch is situated in any angular position between those of at least two pins.

According to another aspect of the invention, it also relates to a restart process using the chopping machine described in the preceding, which is characterized by the fact that
the strands coming from a single die are brought to a position situated between 2 pins,
the anvil wheel is put in rotation in such a way that at least one of the pins intercepts the strands, and the strands are seized by the notch and are wound on the external surface of the plastic wrapping and are then chopped into strand sections.

In some preferred embodiments of the invention, moreover, one and/or another of the following arrangements can possibly be used:
the different elements are positioned in such a way that the path of travel of the strands from the die to a guiding means is completely contained in a vertical plane essentially parallel to a plane passing through the façade of the anvil wheel; then the path of travel of the strands from the guiding means to their entrance into the chopping machine is completely contained in an inclined vertical plane that is secant with respect to the façade of the anvil wheel.
the strands entangled with the pins are extracted by refraction of these pins into housings made in the anvil wheel.

According to another aspect of the invention, it relates to a system for production of chopped strand sections according to the implementation of the process described in the preceding, which is characterized by the fact that it has a number of dies, each associated with a chopping machine, and by the fact that said dies are aligned next to one another.

In some preferred embodiments of the invention, moreover, one and/or another of the following arrangements can be used:
the chopping machines are aligned parallel to the alignment of said dies.

Other characteristics, details, and advantages of the present invention will appear more clearly upon reading of the following description given on an illustrative and purely non-limited basis in reference to the appended drawings in which:

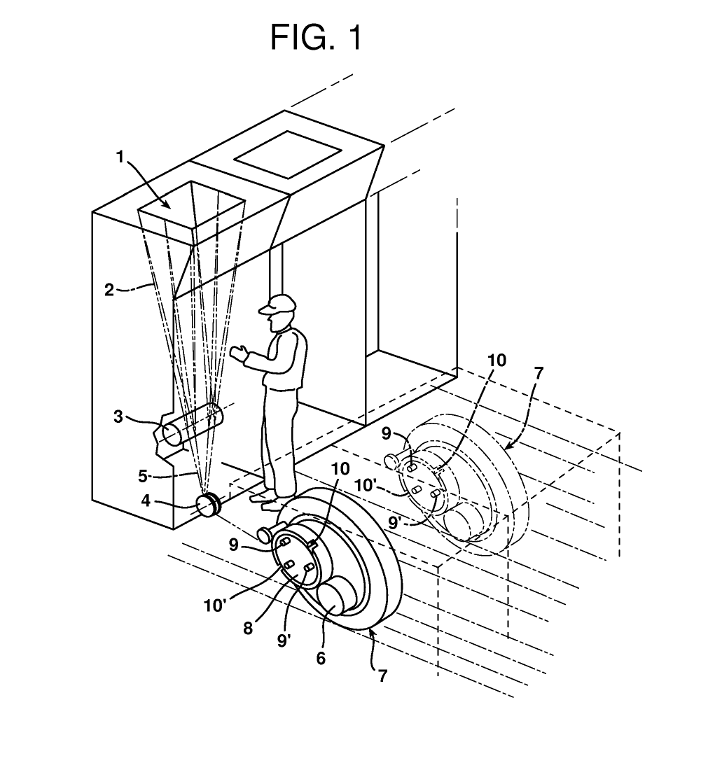

FIG. 1 is a simplified overall perspective view of one embodiment of the invention; and

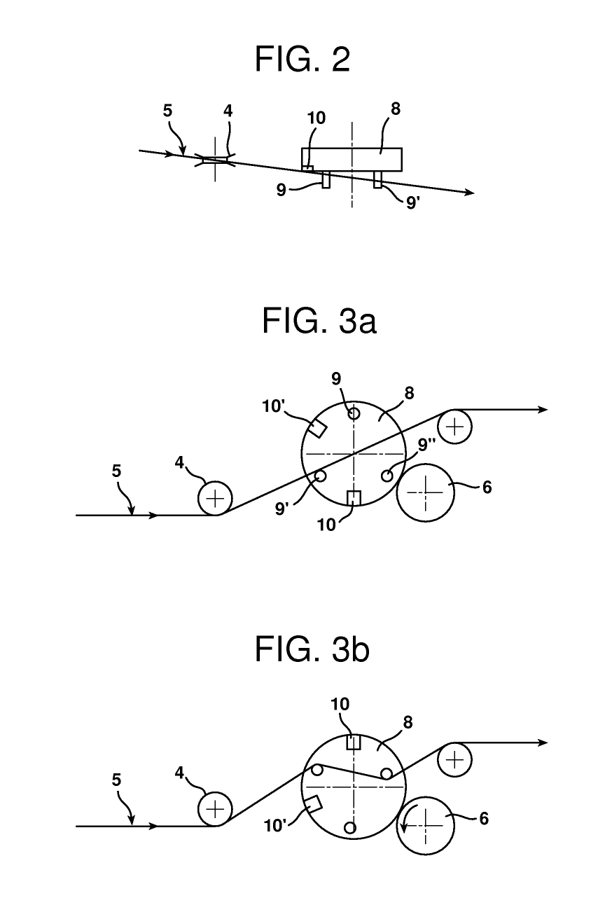

FIG. 2 is one from above the anvil wheel used on the chopper according to the invention;

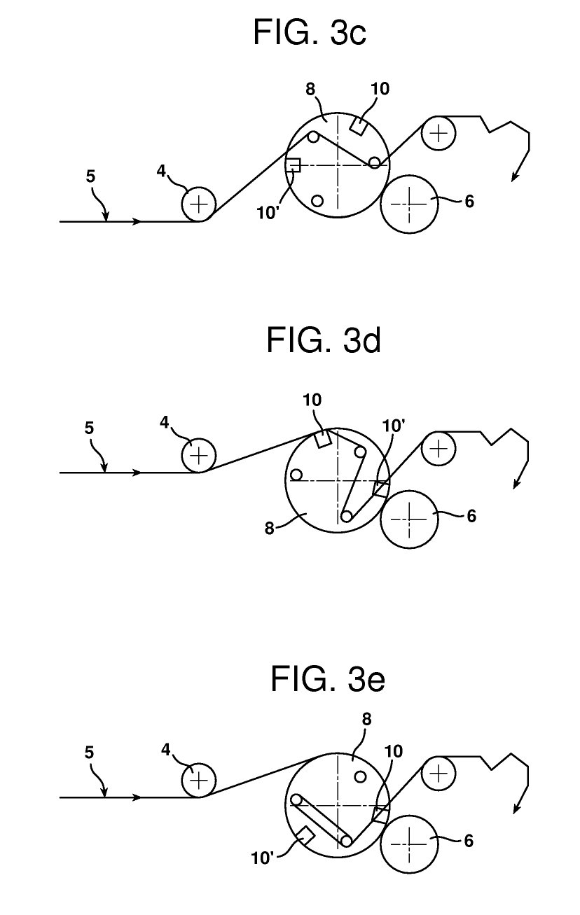

FIGS. 3a to 3e illustrate the path of travel of the strand during the restart phase.

Therefore, appearing diagrammatically in FIG. 1 is the system according to the invention, which has at least one die 1 fed in a known manner using melted glass or glass spheres delivered by a feeding device that is not represented. These dies, for example, made of platinum rhodium alloy, are ordinarily heated by the Joule effect. They are provided at their lower part with a number of openings from which a number of filaments 2 (in this case, certain ones are represented in the form of broken lines) can be drawn out mechanically.

Filaments 2 can be subjected to an oiling operation, that is to say a chemical treatment intended for applying a sizing product or lubricant, thanks to lubricant roller 3.

Filaments 2 coming from a die are then joined in the form of at least one strand that is deflected by a guiding means such as a so-called small deflecting wheel 4 in order to deflect strands 5 and to send them towards chopping machine 7 situated downstream from die assembly 1, lubricant roller 3, and small guide wheel 4.

Without leaving the scope of the invention, chopping machine 7 can be placed behind the die.

Preferably, chopping machine 7 has, on one hand, essentially cylindrical chopping wheel 6 provided on its periphery with a number of uniformly distributed blades oriented essentially according to the direction of its axis of rotation, and on the other hand, anvil wheel 8 lined using a wrapping made of plastic material. Chopping wheel 6 is in the immediate vicinity of anvil wheel 8, so as to drive the anvil wheel by radial contact.

Preferably, anvil wheel 8 is provided on its façade with at least two laterally projecting pins 9, 9′. Advantageously, each of pins 9, 9′ is positioned in one of the four quadrants defining the façade of the anvil wheel. As can be seen in FIG. 2, pins 9, 9′ are essentially situated in a diametrically opposite position.

As a variant, cf. FIGS. 3a to 3e, on the façade of the anvil, the use of 3 pins 9, 9′, 9″ is foreseen, pins that are uniformly distributed over a diameter with each angularly spaced 120° apart.

Regardless of the angular configuration chosen (which depends on the number of pins), it is foreseen that the latter will be mounted either in a fixed manner or in a removable manner, or even in such a way that they can be retracted into housings provided for this purpose, so as to enable the strands to be released as will be explained hereafter.

According to another advantageous characteristic of the invention, anvil wheel 8 is provided with at least one notch 10 situated on the edge of the external surface of the wrapping and at a right angle with respect to the façade of anvil wheel 8 (visible in FIG. 2).

This notch 10 is executed in the added plastic wrapping, made of elastomer in particular, and is obtained directly during molding of the wrapping, or is obtained by a machining station after removal of the wrapping from the mold.

As can be seen in FIGS. 3a to 3e, notch 10 or notches 10, 10′ is (are) preferably positioned in any angular position between those of at least two of pins 9, 9′, 9″. In the example represented in the figures, the position of notch 10, 10′ is essentially median with respect to that of two pins 9, 9′, 9″.

The functioning of this chopping machine in restart phase is the following:
the user grasps a number of filaments 5 coming from the same die or from the single die 1, and these filaments, after oiling, form a strand and are led in guiding means 4 (a wheel or similar) towards chopping machine 7;
strand 5, which needs to be chopped into sections, is brought facing the façade of the anvil wheel and runs between 2 pins (for example, as represented in FIG. 3a). As can be seen in more detail in FIG. 2, the path of travel of strand 5 between guide wheel 4 and pins 9, 9′ follows an oblique trajectory (which is not parallel to the façade of anvil wheel 8), in such a way that the strand can intercept the lateral side of the winding surface of the anvil wheel;
anvil wheel 8 is put in rotation by the intermediary of radial contact with chopping wheel 6 (FIG. 3b);
the strand engages with pins 9, 9′ and produces loops around the latter. Because of the oblique path of travel as explained in the preceding, the strand, because of its engagement on the pins, will arrive tangent to at least one of notches 10, 10′ positioned angularly between 2 pins, and it is seized by at least one of the notches; the strand then goes onto the peripheral winding surface of the anvil wheel (FIGS. 3c, 3d); anvil wheel 8 still rotating draws out the strand (which is not yet chopped into sections) and leads it to the situation represented in FIG. 3e;
in winding on this peripheral surface, the strand is carried along to the zone of radial contact between the chopping wheel and the anvil wheel, running between the blades, and it is stretched and is then chopped into sections that are evacuated, for example, by gravity into a hopper (FIG. 3e).

The strand loops entwined on pins 9, 9′ during the transitional phase are detached, releasing the pins for a later restart operation.

If the anvil wheel is provided with pins that can be retracted into housings provided for this purpose, it can be advantageous to make them retract when the strands are entangled around the pins in such a way as to bring about the automatic evacuation of the strands due to the combined action of the retraction of the pins and the centrifugal force connected with the rotation of the anvil wheel.

Furthermore, the arrangement of the main constituents of the system according to the invention is such that the path of travel of filaments 2 and then of strands 5 is completely contained in a vertical plane, from die 1, to first guiding means 4. More precisely, filaments 2 first of all have an essentially vertical direction from die 1 to small deflecting wheel 4; then strands 5 describe an essentially horizontal path until they go into second guiding means 4′. This vertical plane is essentially parallel to a plane passing through the façade of the anvil wheel.

Starting from this guide wheel 4′, the path of travel of the strands is completely contained in a vertical plane, from this guide wheel 4′ until its passage between chopping wheel 6 and anvil wheel 8. This vertical plane is, in this part of the installation, secant with respect to the vertical plane containing the façade of the anvil wheel, as appears in FIG. 2. In this way, the path of travel of the strands intercepts the trajectory of the notch that is supposed to seize the strands and direct them by rotation towards the zone of contact between the chopping wheel and the anvil wheel.

Die 1 and lubricant roller 3 are preferably arranged one above the other, for example, in the same fiber forming cell that rests on a floor, on which chopping machine 7 lies downstream from the fiber forming cell.

Small deflecting wheel 4 is preferably arranged plumb with lubricant roller 3.

Thus, filaments 2 have an essentially vertical path of travel from die 1 to small deflecting roller 4 that deflects the strands approximately 90° in order to lead them horizontally (or essentially horizontally) towards chopping machine 7. This chopping machine is placed downstream from the fiber forming cell.

The present invention makes it possible to maintain a division of the strands from small deflecting wheel 4 until contact with anvil wheel 8 and the chopping wheel. The simplicity of the path of travel of strands 5 from small deflecting wheel 4 to chopping machine 7 in effect makes it possible to maintain this division in a simple and therefore reliable manner. This separation device will make it possible to produce chopped strands using large dies provided with several thousand nozzles without running into problems of chopping quality or premature wear and tear of the drawing cylinders.

The restart in chopping machine 7 could be automated without difficulty, thus eliminating any human intervention; in effect, the strand could be taken automatically by the strand puller situated under small wheel 5.

The present invention advantageously makes it possible to meet the increasing requirements of the client regarding quality.

Furthermore, the arrangement according to the invention makes complete control of each die possible. It is in effect possible to suitably adapt the speed of each chopping machine 7 to the discharge rate of the associated die 1. A specific adjustment of the discharge rate is therefore brought about for each die-chopper assembly so that a high quality product can be obtained. Compliance with specifications is improved according to the invention.

Each die 1-chopper 7 assembly according to the invention requires a reduced amount of space; its width can be on the order of 0.5 m; its depth is at least approximately 1.30 m while its total height is approximately 1.30 meters.

A preferred arrangement of the invention can consist of an alignment of a number of assemblies (or modules) 1-7 as represented diagrammatically and partially in FIG. 1.

Thus, an operator can easily oversee all the die 1-chopper 7 assemblies and quickly intervene on a faltering assembly without the others undergoing the least disturbance.

Furthermore, such an arrangement makes productions of different natures possible with as many modules as are necessary. This production flexibility, regarding not only the nature of the production but also its quantity, is another inherent advantage of the present invention.

An appropriate number of modules can be installed as needed. According to the desired production, all or some of the modules can be operated simultaneously. Likewise, the development of a new fiber forming process can take place on an isolated module without interrupting or disturbing the operation of the other modules.

The improvements mentioned above, which are in no way limiting, must of course be considered to be the result of the combination of the constitutive elements of the invention.

1. A chopping machine for use in chopping sections having a predetermined length from strands of thermoplastic material drawn from a single die comprising:
a cylindrical chopping wheel having a periphery with a number of uniformly distributed blades oriented about an axis of rotation;
an anvil wheel having a peripheral surface wrapped in a plastic material and a façade substantially perpendicular to the peripheral surface, said anvil wheel being in the vicinity of the chopping wheel; and
a routing device on the façade having at least two pins projecting laterally each pin arranged in a different quadrant of said façade.

2. The chopping machine of claim 1, wherein the façade of the anvil wheel has at least 3 pins.

3. The chopping machine of claim 1, wherein the anvil wheel is provided with at least one notch on an edge of an external surface of the plastic material and at a right angle with respect to the façade of anvil wheel.

4. The chopping machine of claim 1, wherein the pins are mounted in a removable manner.

5. The chopping machine of claim 3, wherein the notch is situated between two pins.

6. A chopping machine restart process, comprising the steps of:
rotating an anvil wheel having a peripheral surface wrapped in a plastic material and a façade substantially perpendicular to the peripheral surface, the façade having at least two pins projecting laterally and each pin arranged in a different quadrant of the façade;
rotating a cylindrical chopping wheel adjacent the anvil wheel;
drawing strands to a position situated between 2 pins on the rotating anvil wheel; and
intercepting the strands , such that the strands are seized by a notch in the peripheral surface and are wound on an external surface of the plastic material and are chopped into strand sections by the cylindrical chopping wheel.

7. The restart process of claim 6, wherein the chopping wheel and the anvil wheel are positioned such that the path of travel of the strands from the die to a guide is within a vertical plane essentially parallel to a plane passing through the façade of the anvil wheel and the path of travel of the strands from the guide to the chopping machine is within an inclined vertical plane that is secant to the façade of the anvil wheel.

8. The restart process of claim 6, wherein the strands are entangled with the pins and are disentangled by retraction of the pins into the anvil wheel.

9.-10. (canceled)

11. A chopping machine for chopping strand into sections, comprising:
a cylindrical chopping wheel having a periphery with a number of cutting blades;
an anvil wheel having a plastic peripheral surface, an end face substantially perpendicular to the peripheral surface, and an edge separating the peripheral surface and the end face; and
a routing device on the end face of the anvil wheel having a plurality of pins projecting from the end face, the pins being movable with respect to the end face.

12. The chopping machine of claim 11, further comprising at least 3 pins.

13. The chopping machine of claim 11, further comprising a plurality of housings formed in the anvil wheel, each housing receiving one of said pins, the pins being retractable into the housings.

14. The chopping machine of claim 11, wherein the anvil wheel is provided with at least one notch on the edge, the notch being perpendicular to the end face of the anvil wheel.

15. The chopping machine of claim 14, wherein the at least one notch is situated between two adjacent pins.

16. The chopping machine of claim 14, further comprising a plurality of notches formed in the anvil wheel.

17. The chopping machine of claim 16, wherein the plurality of notches are formed between adjacent pins.

18. The chopping machine of claim 11, wherein the anvil wheel includes four quadrants, each quadrant having no more than one pin mounted thereon.

19. The chopping machine of claim 11, wherein the chopping wheel and the anvil wheel are coplanar with the strands, and the path of travel of the strands to the chopping machine is within a vertical plane that is secant to the end face of the anvil wheel.

20. The chopping machine of claim 11, wherein the pins are moveable from a first position, configured to entangle the strands, to a second, retracted position within the anvil wheel.
